(19) United States
(12) Patent Application Publication
(10) Pub. No.: US 2008/0189954 A1
(43) Pub. Date: Aug. 14, 2008

(54) Pipe cutter

(76) Inventor: Yung Sheng Lin, Dali City (TW)

Correspondence Address: CHARLES E. BAXLEY, ESQUIRE, 90 JOHN STREET, SUITE 309, NEW YORK, NY, 10038, US

(21) Appl. No.: 11/397,876

(22) Filed: Apr. 4, 2006

(51) Int. Cl. B23D 21/06

(52) U.S. Cl. 30/92

(57) ABSTRACT

A pipe cutter includes a housing having a handle for being held by a user and a notch for receiving a pipe to be cut, a cutter blade slidably received in the housing and having a number of teeth, a latch having a tongue biased to engage with the teeth of the cutter blade for limiting the cutter blade to move relative to the housing, a trigger pivotally coupled to the housing and having a pawl biased to engage with the teeth of the cutter blade, and a knob slidably engaged in the housing for being actuated by the user to selectively disengage the tongue of the latch from the teeth of the cutter blade. A lock device may selectively engage with the trigger to prevent the cutter blade from being moved inadvertently by the children.

### BACKGROUND OF THE INVENTION

1. Field of the Invention

The present invention relates to a pipe cutter, and more particularly to a pipe cutter having a quick release latching device for quick releasing the cutter blade and for allowing the cutter blade to be quickly sprung back to the original position.

2. Description of the Prior Art

Typical pipe cutters comprise a movable member or a carrier slidably received or engaged in a longitudinal channel of an outer body or housing for supporting a cutter blade, and a trigger or handle coupled to the carrier or the cutter blade and for moving the carrier or the cutter blade forwardly step by step, and a dog member or latch device coupled to the carrier or the cutter blade for preventing the carrier or the cutter blade from being moved rearwardly.

For example, U.S. Pat. No. 5,018,275 to Huang discloses one of the typical pipe cutters also comprising a spring-biased dog member for coupling to or for engaging with the carrier or the cutter blade and for preventing the carrier or the cutter blade from being moved rearwardly, and for allowing the carrier or the cutter blade to be quickly sprung back to the original position when the spring-biased dog member is depressed or actuated by the user.

However, the spring-biased dog member is engaged with the carrier or the cutter blade with a frictional engagement, such that the carrier or the cutter blade may have a good chance to slide relative to the spring-biased dog member when the frictional engagement between the spring-biased dog member and the carrier or the cutter blade has become fail, or when dirt has been applied or engaged between the spring-biased dog member and the carrier or the cutter blade.

U.S. Pat. No. 5,046,250 to Huang discloses another typical pipe cutter comprising a check pawl biased to engage with a blade driving gear by a compression spring, and selectively disengageable from the blade driving gear by an arm, in which the arm is slidably received in a hand grip member that will be grasped and held by the users, and the arm is also extended rearwardly from the hand grip member.

However, the arm will also be depressed or actuated by the hand of the users that grasp or hold the hand grip member inadvertently, such that the blade driving gear and thus the cutter blade will be released inadvertently, and such that the user may have to move the cutter blade forwardly toward the work piece again and again.

U.S. Pat. No. 5,070,616 to Chen discloses a further typical pipe cutter comprising a hydraulic actuating device for actuating or moving the cutter blade forwardly toward the work piece with a handle, and a pin for selectively releasing the oil flowing passage and for allowing the cutter blade to be quickly sprung back to the original position.

However, the hydraulic actuating device and the oil flowing passage may have an oil leaking problem after use, and the oil leaking problem may also be occurred after a time interval even when the hydraulic actuating device has never been used.

U.S. Pat. No. 5,218,765 to Huang discloses a still further typical pipe cutter comprising a slide slidably received or engaged in a longitudinal channel of an outer body or housing for supporting a cutter blade, and a trigger or handle coupled to the slide or the cutter blade and for moving the slide or the cutter blade forwardly step by step with a gear wheel, and a pawl for engaging with the gear wheel and for preventing the slide or the cutter blade from being moved rearwardly.

However, the pawl may be actuated by a follower only when the slide or the cutter blade has been moved forwardly toward the frontmost position of the outer body or housing, such that the slide or the cutter blade may not be moved rearwardly toward the rearmost position of the outer body or housing at any time by the users.

The present invention has arisen to mitigate and/or obviate the afore-described disadvantages of the conventional pipe cutters.

### SUMMARY OF THE INVENTION

The primary objective of the present invention is to provide a pipe cutter including a quick release latching device for quick releasing the cutter blade and for allowing the cutter blade to be quickly sprung back to the original position.

In accordance with one aspect of the invention, there is provided a pipe cutter comprising a housing including a handle extended downwardly from the housing for being held by a user, and including a notch formed in a front portion of the housing for receiving a pipe to be cut, and including a channel formed in the housing and communicating with the notch of the housing, a cutter blade slidably received in the channel of the housing, and including a plurality of teeth formed therein, and including a cutter edge for being moved to engage with and to cut the pipe, a first spring member coupled between the housing and the cutter blade for biasing the cutter blade into the channel of the housing and for biasing and moving the cutter edge of the cutter blade away from the pipe, a latch slidably received in the housing and movable up and down relative to the housing, and including a tongue extended from the latch for engaging with the teeth of the cutter blade and for limiting the cutter blade to move relative to the housing and for preventing the cutter blade from moving rearwardly relative to the housing, a second spring member disposed in the housing and engaged with the latch for biasing the tongue of the latch to engage with the teeth of the cutter blade and for limiting the cutter blade to move relative to the housing, a trigger pivotally coupled to the housing with a pivot axle and arranged for allowing the trigger to be pivoted and moved toward and away form the handle, a pawl slidably received in the trigger, and including an oblong hole formed in the pawl for slidably receiving the pivot axle and for allowing the pawl to be moved relative to the trigger, and including an actuator for engaging with the teeth of the cutter blade and for moving the cutter blade forwardly relative to the housing, a third spring member disposed in the trigger and engaged with the pawl for biasing the actuator of the pawl to engage with the teeth of the cutter blade and for allowing the actuator of the pawl to be moved rearwardly relative to the housing and to be moved away from the cutter blade against the third spring member, and for allowing the cutter blade to be moved forwardly relative to the housing step by step by the trigger and the pawl, and a knob slidably engaged in the housing and partially extended out of the housing for being actuated by the user, and movable by the user to engage with the latch for selectively disengaging the tongue of the latch from the teeth of the cutter blade against the second spring member.

The trigger includes a slot formed in an upper portion thereof for slidably receiving the pawl. The trigger includes a cavity formed therein for receiving the third spring member. The pawl includes an extension extended therefrom and engaged with the third spring member for allowing the third spring member to bias the actuator of the pawl to engage with the teeth of the cutter blade.

The latch is slidably disposed beside the cutter blade and includes an upper end for engaging with the knob and for allowing the tongue of the latch to be disengaged from the teeth of the cutter blade by the knob. The housing includes a fourth spring member for engaging with the knob and for biasing the knob away from the latch. The housing includes a conduit formed therein for slidably receiving the latch and for guiding the latch to move relative to the housing.

The cutter blade includes a passage formed therein, and a follower is slidably received in the housing and includes a projection extended therefrom and slidably engaged into the passage of the cutter blade for being engaged with the cutter blade and for allowing the follower to be moved forwardly by the cutter blade to engage with the latch and to disengage the tongue of the latch from the teeth of the cutter blade when the pipe has been cut by the cutter blade, for allowing the cutter blade to be sprung back by the first spring member.

The latch includes an inclined surface formed therein, and the follower includes an inclined surface for selectively engaging with the inclined surface of the latch when the follower is moved to engage with the latch by the cutter blade.

A lock device is slidably received in the handle and movable toward the trigger to selectively engage with the trigger and to space and to anchor the trigger to the handle and to prevent the trigger from being moved toward the handle, for preventing the cutter blade from being moved forwardly relative to the housing inadvertently by such as the children. The lock device includes a knob for moving the lock device toward and away from the trigger and for rotating the lock device relative to the trigger by the user.

The housing includes a groove formed therein for slidably receiving the lock device therein, and includes a compartment and communicating with the groove of the housing, the lock device includes a catch extended therefrom and movable and engageable into the compartment of the housing when the lock device is rotated relative to the housing for maintaining the lock device in engagement with the trigger.

The housing includes a fourth spring member for engaging with the lock device and for biasing the lock device away from the trigger. The housing a fourth spring member is engaged between the handle and the trigger for biasing the trigger away from the handle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a pipe cutter in accordance with the present invention;

FIG. 2 is an exploded view of the pipe cutter;

FIG. 3 is an enlarged partial perspective view of the pipe cutter;

FIG. 4 is a partial cross sectional view of the pipe cutter, taken along lines 4-4 of FIG. 1; and

FIGS. 5, 6, 7 are partial cross sectional views similar to FIG. 4, illustrating the operation of the pipe cutter.

### DETAILED DESCRIPTION OF THE PREFERRED EMBODIMENT

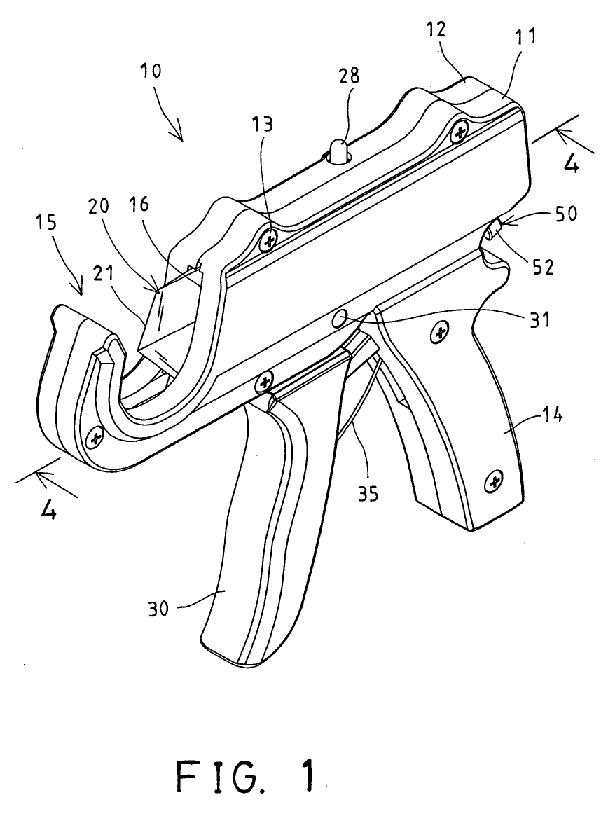

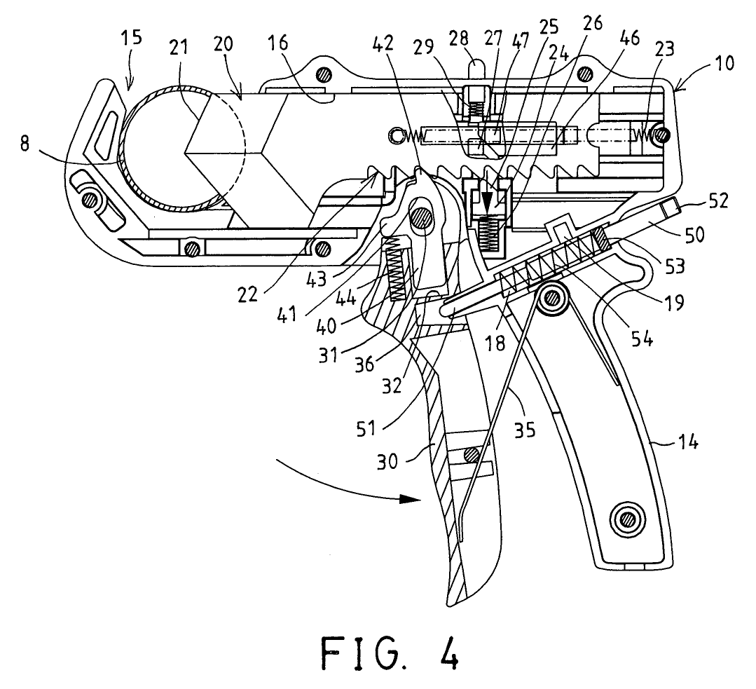

Referring to the drawings, and initially to FIGS. 1-4, a pipe cutter in accordance with the present invention comprises a body or housing 10 including such as two housing members 11, 12 detachably secured together with such as latches or fasteners 13, or with adhesive materials or by welding processes, and including a handle 14 extended downwardly from such as the rear portion of the housing 10 for being grasped or held by the users, and including a notch 15 formed in the front portion of the housing 10 for receiving a pipe 8 to be severed or cut by the pipe cutter, and including a channel 16 formed in the front or middle portion of the housing 10 and communicating with the notch 15 of the housing 10 for slidably receiving a cutter blade 20 therein. The pipe 8 may include various kinds of cross section or contours, such as circular-shaped cross section for being cut by the pipe cutter.

The cutter blade 20 includes a cutter edge 21 provided or formed on the front portion thereof for being moved to engage with the pipe 8 and for being forced to cut the pipe 8, and further includes a number of teeth 22, such as ratchet teeth 22 formed in the bottom portion thereof. A spring member 23 may be provided and engaged in the housing 10 and coupled between the rear portion of the housing 10 and the cutter blade 20 for biasing or pulling the cutter blade 20 into the channel 16 of the housing 10 and thus for biasing or moving the cutter edge 21 of the cutter blade 20 away from the pipe 8 or from the notch 15 of the housing 10, and thus for allowing the pipe 8 to be engaged into the notch 15 of the housing 10.

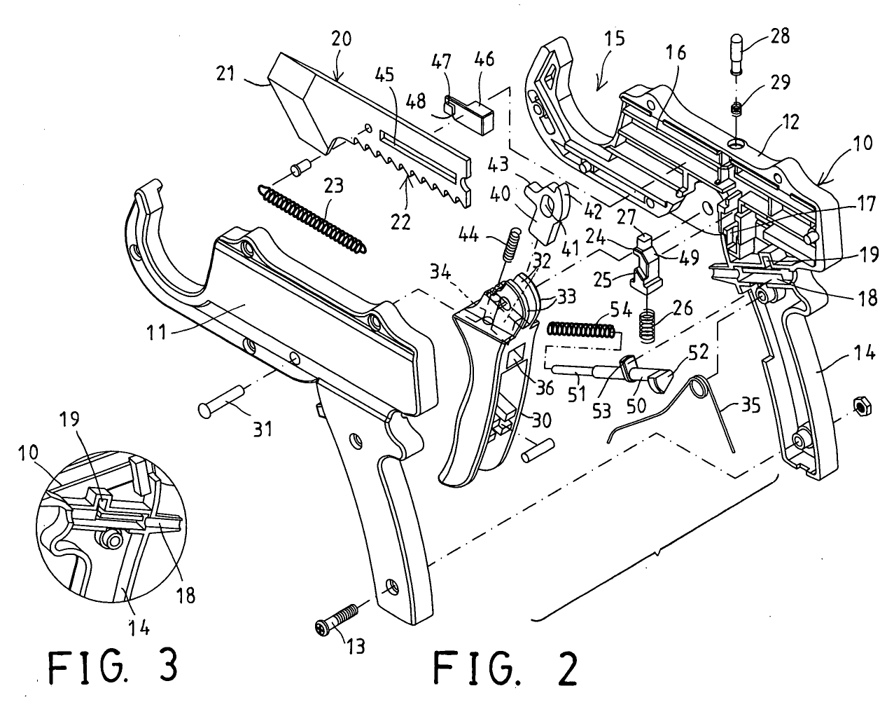

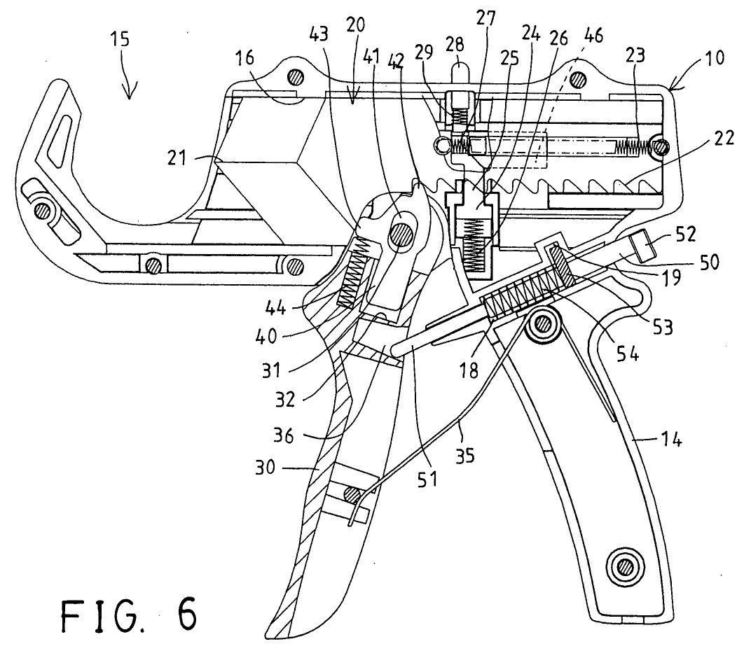

A latch 24 is guided and slidably received in a conduit 17 (FIG. 2) that is formed in the middle portion of the housing 10, and arranged for allowing the latch 24 to be moved up and down relative to the housing 10, and the conduit 17 of the housing 10 may also be used to limit the latch 24 to move relative to the housing 10. The latch 24 is slidably disposed beside the cutter blade 20, and includes a tooth or tongue 25 formed or extended from one side and lower portion of the latch 24 for engaging with the teeth 22 of the cutter blade 20, and for limiting the cutter blade 20 to move relative to the housing 10, and for preventing the cutter blade 20 from moving rearwardly relative to the housing 10. Another spring member 26 may further be provided and disposed in the housing 10 and engaged with the latch 24 for biasing the tongue 25 of the latch 24 to engage with the teeth 22 of the cutter blade 20 (FIG. 6), and thus for limiting the cutter blade 20 to move relative to the housing 10.

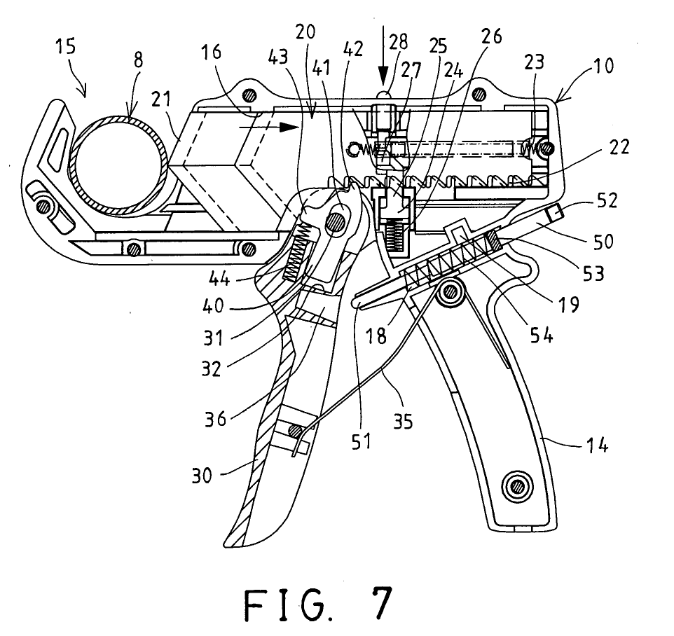

A button or knob 28 may further be provided and slidably engaged in the upper portion of the housing 10, and partially extended out of the housing 10 for being depressed or actuated by the user, and movable downwardly to engage with an upper end 27 of the latch 24, for selectively moving the latch 24 downwardly relative to the housing 10 and for selectively disengaging the tongue 25 of the latch 24 from the teeth 22 of the cutter blade 20 (FIG. 7) against the spring member 26. A further spring member 29 may optionally be provided and engaged in the housing 10 and engaged with the knob 28 for biasing the knob 28 away from the upper end 27 of the latch 24. It is to be noted that the spring member 26 may also be used to bias the knob 28 out of the housing 10 without the spring member 29.

A trigger 30 is rotatably or pivotally coupled to the housing 10 with a pivot axle 31 and arranged for allowing the trigger 30 to be pivoted or moved toward and away form the handle 14, the trigger 30 includes a slot 32 formed in the upper portion thereof and defined between two flaps 33 for slidably receiving a pawl 40 therein. The pawl 40 includes an oblong hole 41 formed therein for slidably receiving the pivot axle 31 and thus for allowing the pawl 40 to be moved up and down relative to the trigger 30 and also for guiding and limiting the pawl 40 to move relative to the trigger 30. The pawl 40 further includes an upper end or actuator 42 for engaging with the teeth 22 of the cutter blade 20, and for allowing the cutter blade 20 to be moved forwardly relative to the housing 10 step by step by the trigger 30 and the pawl 40.

The pawl 40 further includes an extension 43 extended therefrom, and the trigger 30 further includes a cavity 34 formed in the upper portion thereof for receiving a further spring member 44 which is engaged with the extension 43 of the pawl 40 for biasing the actuator 42 of the pawl 40 engage with the teeth 22 of the cutter blade 20, and for allowing the actuator 42 of the pawl 40 to be moved rearwardly relative to the housing 10 and to be moved away from the cutter blade 20 against the spring member 44, and thus for allowing the cutter blade 20 to be moved forwardly relative to the housing 10 step by step by the trigger 30 and the pawl 40.

A still further spring member 35 may be provided and engaged between the housing 10 and the trigger 30 for biasing the trigger 30 away form the handle 14, and thus for allowing the actuator 42 of the pawl 40 to be moved rearwardly relative to the cutter blade 20 against the spring member 44 when the trigger 30 is released by the user and when the trigger 30 is biased by the spring member 35. The actuator 42 of the pawl 40 may thus be used to move the cutter blade 20 forwardly relative to the housing 10 step by step by the trigger 30, and the tongue 25 of the latch 24 may be biased to engage with the teeth 22 of the cutter blade 20 to limit the cutter blade 20 to move relative to the housing 10, and to prevent the cutter blade 20 from moving rearwardly relative to the housing 10.

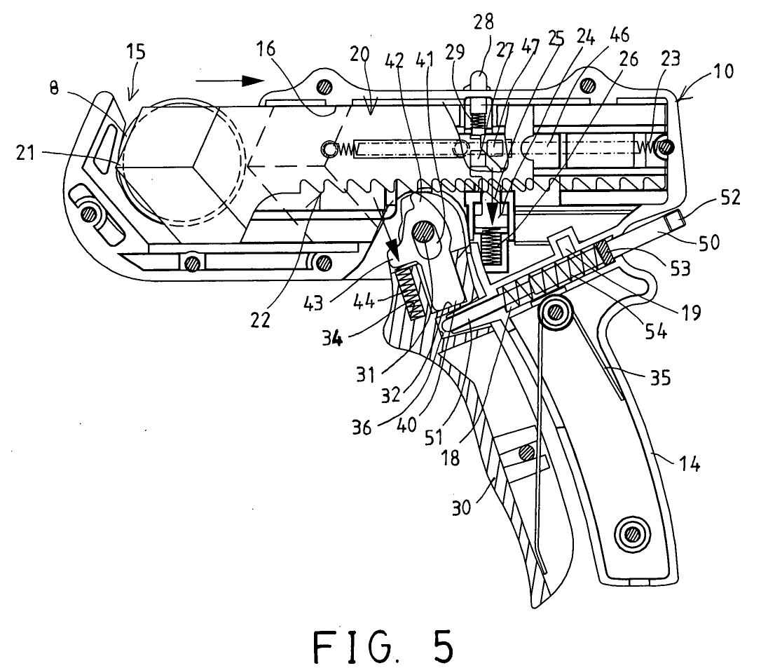

It is preferable that the latch 24 and the pawl 40 and the cutter blade 20 are arranged for allowing the cutter blade 20 to be quickly sprung or biased to move rearwardly relative to the housing 10 or to move backwardly to the rearmost position of the housing 10 (FIG. 5) when the cutter blade 20 has been moved forwardly toward the frontmost position of the housing 10. For example, the cutter blade 20 includes a longitudinal passage 45 formed in the middle or rear portion thereof, a follower 46 is slidably received in the housing 10 and includes a projection 47 extended therefrom and slidably engaged into the passage 45 of the cutter blade 20.

The projection 47 of the follower 46 may be engaged in the rear end or portion of the passage 45 of the cutter blade 20 and may be engaged with the cutter blade 20 when the cutter blade 20 has moved forwardly toward and close to the frontmost position of the housing 10, for allowing the follower 46 to be moved forwardly by the cutter blade 20 after or when the pipe 8 has been completely cut by the cutter blade 20. The follower 46 may then be caused to engage with the latch 24, in order to disengage the tongue 25 of the latch 24 from the teeth 22 of the cutter blade 20, and thus to release the cutter blade 20, and thus for allowing the cutter blade 20 to be quickly sprung or biased to move backwardly to the rearmost position of the housing 10 by the spring member 23 when the pipe 8 has been completely cut by the cutter blade 20.

It is preferable that the follower 46 includes an inclined surface 48 formed therein, such as formed in the lower portion thereof, for engaging with a corresponding inclined surface 49 (FIG. 2) that is formed in the upper portion of the latch 24, or for directly engaging with the upper end 27 of the latch 24 for allowing the latch 24 to be easily and smoothly moved downwardly relative to the cutter blade 20 and the housing 10 by the follower 46 and the cutter blade 20, and for allowing the cutter blade 20 to be quickly sprung or biased to move backwardly to the rearmost position of the housing 10 by the spring member 23 when the latch 24 is moved downwardly relative to the cutter blade 20 by the follower 46.

However, the most important feature of the present invention is that the latch 24 includes a tooth or tongue 25 formed or extended from one side portion of the latch 24 for solidly engaging with the teeth 22 of the cutter blade 20, and for effectively limiting the cutter blade 20 to move relative to the housing 10, and for safely preventing the cutter blade 20 from moving forwardly relative to the housing 10 inadvertently. In addition, the knob 28 that is partially extended out of the housing 10 may be moved downwardly to engage with the upper end 27 of the latch 24, and to selectively move the latch 24 downwardly relative to the housing 10 and thus for selectively disengaging the tongue 25 of the latch 24 from the teeth 22 of the cutter blade 20 even when the cutter blade 20 has not been moved forwardly toward the frontmost position of the housing 10 (FIG. 7).

The housing 10 further includes a groove 18 provided or formed in the rear portion thereof or formed between the housing 10 and the handle 14, or formed in the upper portion of the handle 14, for slidably receiving a safety lock device 50 therein, and further includes a compartment 19 formed in the housing 10 or in the handle 14 and communicating with the groove 18 of the housing 10 or the handle 14. The lock device 50 includes one end or front end 51 movable toward the trigger 30, and engageable in an aperture 36 of the trigger 30 (FIG. 6), for spacing the trigger 30 from the handle 14 and also for anchoring the trigger 30 to the handle 14, and for preventing the trigger 30 from being moved toward the handle 14, and thus for preventing the cutter blade 20 from being moved forwardly relative to the housing 10 inadvertently by such as the children.

The lock device 50 further includes a knob 52 formed or provided in the rear portion thereof for moving the lock device 50 toward and away from the trigger 30, and for rotating the lock device 50 relative to the trigger 30, and further includes a catch 53 extended from a middle portion thereof and movable and engageable into the compartment 19 of the housing 10 when the lock device 50 is rotated relative to the housing 10, for locking or maintaining the front end 51 of the lock device 50 in engagement with the trigger 30 and thus for preventing the cutter blade 20 from being moved forwardly relative to the housing 10 inadvertently by such as the children. A spring member 54 may further be provided and engaged between the lock device 50 and the trigger 30 for biasing the front end 51 of the lock device 50 away form the trigger 30 when the catch 53 of the lock device 50 is disengaged from the compartment 19 of the housing 10 or the handle 14.

It is to be noted that the latch 24 includes a tooth or tongue 25 formed or extended from one side and lower portion for solidly engaging with the teeth 22 of the cutter blade 20, and for effectively preventing the cutter blade 20 from moving rearwardly relative to the housing 10. In addition, the one end or front end 51 of the lock device 50 may be moved to engage with the trigger 30, such as to engage with the aperture 36 of the trigger 30, for anchoring the trigger 30 to the handle 14, and for preventing the trigger 30 from being moved toward the handle 14, and thus for preventing the cutter blade 20 from being moved forwardly relative to the housing 10 inadvertently by such as the children, such that the lock device 50 may be used or acted as a safety device for selectively locking the trigger 30 to the handle 14.

Accordingly, the pipe cutter in accordance with the present invention includes a quick release latching device for quick releasing the cutter blade and for allowing the cutter blade to be quickly sprung back to the original position.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pipe cutter comprising:
a housing including a handle extended downwardly from said housing for being held by a user, and including a notch formed in a front portion of said housing for receiving a pipe to be cut, and including a channel formed in said housing and communicating with said notch of said housing,
a cutter blade slidably received in said channel of said housing, and including a plurality of teeth formed therein, and including a cutter edge for being moved to engage with and to cut the pipe,
a first spring member coupled between said housing and said cutter blade for biasing said cutter blade into said channel of said housing and for biasing and moving said cutter edge of said cutter blade away from the pipe,
a latch slidably received in said housing and movable up and down relative to said housing, and including a tongue extended from said latch for engaging with said teeth of said cutter blade and for limiting said cutter blade to move relative to said housing and for preventing said cutter blade from moving rearwardly relative to said housing,
a second spring member disposed in said housing and engaged with said latch for biasing said tongue of said latch to engage with said teeth of said cutter blade and for limiting said cutter blade to move relative to said housing,
a trigger pivotally coupled to said housing with a pivot axle and arranged for allowing said trigger to be pivoted and moved toward and away form said handle,
a pawl slidably received in said trigger, and including an oblong hole formed in said pawl for slidably receiving said pivot axle and for allowing said pawl to be moved relative to said trigger, and including an actuator for engaging with said teeth of said cutter blade and for moving said cutter blade forwardly relative to said housing,
a third spring member disposed in said trigger and engaged with said pawl for biasing said actuator of said pawl to engage with said teeth of said cutter blade and for allowing said actuator of said pawl to be moved rearwardly relative to said housing and to be moved away from said cutter blade against said third spring member, and for allowing said cutter blade to be moved forwardly relative to said housing step by step by said trigger and said pawl, and
a knob slidably engaged in said housing and partially extended out of said housing for being actuated by the user, and movable by the user to engage with said latch for selectively disengaging said tongue of said latch from said teeth of said cutter blade against said second spring member.

2. The pipe cutter as claimed in claim 1, wherein said trigger includes a slot formed in an upper portion thereof for slidably receiving said pawl.

3. The pipe cutter as claimed in claim 1, wherein said trigger includes a cavity formed therein for receiving said third spring member.

4. The pipe cutter as claimed in claim 1, wherein said pawl includes an extension extended therefrom and engaged with said third spring member for allowing said third spring member to bias said actuator of said pawl to engage with said teeth of said cutter blade.

5. The pipe cutter as claimed in claim 1, wherein said latch is slidably disposed beside said cutter blade and includes an upper end for engaging with said knob and for allowing said tongue of said latch to be disengaged from said teeth of said cutter blade by said knob.

6. The pipe cutter as claimed in claim 1, wherein said housing includes a fourth spring member for engaging with said knob and for biasing said knob away from said latch.

7. The pipe cutter as claimed in claim 1, wherein said housing includes a conduit formed therein for slidably receiving said latch and for guiding said latch to move relative to said housing.

8. The pipe cutter as claimed in claim 1, wherein said cutter blade includes a passage formed therein, and a follower is slidably received in said housing and includes a projection extended therefrom and slidably engaged into said passage of said cutter blade for being engaged with said cutter blade and for allowing said follower to be moved forwardly by said cutter blade to engage with said latch and to disengage said tongue of said latch from said teeth of said cutter blade when the pipe has been cut by said cutter blade, for allowing said cutter blade to be sprung back by said first spring member.

9. The pipe cutter as claimed in claim 8, wherein said latch includes an inclined surface formed therein, and said follower includes an inclined surface for selectively engaging with said inclined surface of said latch when said follower is moved to engage with said latch by said cutter blade.

10. The pipe cutter as claimed in claim 1, wherein a lock device is slidably received in said handle and movable toward said trigger to selectively engage with said trigger and to space and to anchor said trigger to said handle and to prevent said trigger from being moved toward said handle, for preventing said cutter blade from being moved forwardly relative to said housing inadvertently by such as said children.

11. The pipe cutter as claimed in claim 10, wherein said lock device includes a knob for moving said lock device toward and away from said trigger and for rotating said lock device relative to said trigger by the user.

12. The pipe cutter as claimed in claim 10, wherein said housing includes a groove formed therein for slidably receiving said lock device therein, and includes a compartment and communicating with said groove of said housing, said lock device includes a catch extended therefrom and movable and engageable into said compartment of said housing when said lock device is rotated relative to said housing for maintaining said lock device in engagement with said trigger.

13. The pipe cutter as claimed in claim 10, wherein said housing includes a fourth spring member for engaging with said lock device and for biasing said lock device away from said trigger.

14. The pipe cutter as claimed in claim 1, wherein said housing a fourth spring member is engaged between said handle and said trigger for biasing said trigger away from said handle.
